(19) United States
(12) Patent Application Publication
(10) Pub. No.: US 2008/0227463 A1
(43) Pub. Date: Sep. 18, 2008

(54) DETERMINING LOCATION INFORMATION

(75) Inventors: RYOKO HIZUME, KANAGAWA (JP); ETSUKO NAKAMOTO, TOKYO (JP); YOSHITSUGU TAKAKU, TOKYO (JP)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/686,123

(22) Filed: Mar. 14, 2007

(51) Int. Cl. H04B 1/38; H04Q 7/20

(52) U.S. Cl. 455/456.1

(57) ABSTRACT

A method (300) of determining location information for an electronic device (100), the method (300) comprising receiving initial location information associated with the electronic device (305), determining proximate access point identifiers which identify a number of access points (225) corresponding to the initial location information (310), forwarding the proximate access point identifiers (315), receiving proximate access point location information associated with at least some of the proximate access point identifiers (320), determining final location information using the proximate access point location information (325), forwarding the final location information (330).

### FIELD OF THE INVENTION

The present invention relates to determining the location of an electronic device such as a mobile telephone.

### BACKGROUND

Electronic devices such as mobile telephones, personal digital assistants, and notebook computers may be moved between different locations by a user. Increasingly there is an interest in locating these electronic devices, for example to help the user with navigation. A well known example is the use of global positioning satellites (GPS), the signals from which can be used to triangulate from the known locations of the satellites. Other examples include radio frequency based location systems, for example to triangulate using the signals from a number of cellular base stations; radar, and proximity devices.

GPS and other radio frequency based technologies work well in outdoor line-of-sight conditions but are less accurate indoors. They may also be expensive to implement in a cost effective electronic device which has no other need for these technologies.

The presence of nearby access points or base stations having known positions may be used to locate an electronic device. The electronic device queries any nearby access points and determines their signal strength. This location information may then be forwarded to a location server which triangulates the known positions of the identified access points together with their signal strengths as a proxy for range, in order to calculate the position of the electronic device.

### BRIEF DESCRIPTION OF THE DRAWINGS

In order that the invention may be readily understood and put into practical effect, reference will now be made to exemplary embodiments as illustrated with reference to the accompanying figures, where like reference numerals refer to identical or functionally similar elements throughout the separate views. The figures together with a detailed description below, are incorporated in and form part of the specification, and serve to further illustrate the embodiments and explain various principles and advantages, in accordance with the present invention where:

FIG. 1 is a schematic of an electronic device suitable according to an embodiment of the present invention;

FIG. 2 is a schematic of a system for determining location information according to an embodiment of the present invention and including the electronic device of FIG. 1 together with a location server;

FIGS. 3A and 3B are a flow diagrams illustrating methods of determining location information for an electronic device according to embodiments of the present invention; and

FIG. 4 is a schematic of another system for determining location information according to an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and device components related to determining location information for an electronic device. Accordingly, the device components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a method, or device that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element. Also, throughout this specification the term “key” has the broad meaning of any key, button or actuator having a dedicated, variable or programmable function that is actuatable by a user.

It will be appreciated that embodiments of the invention described herein may be comprised of one or more conventional processors and unique stored program instructions that control the one or more processors to implement, in conjunction with certain non-processor circuits, some, most, or all of the functions of determining location information for an electronic device described herein. The non-processor circuits may include, but are not limited to, a radio receiver, a radio transmitter, signal drivers, clock circuits, power source circuits, and user input devices. As such, these functions may be interpreted as steps of a method for determining location information for an electronic device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

According to one aspect of the present invention there is provided a method of determining location information for an electronic device, the method comprising: receiving initial location information associated with the electronic device; determining proximate access point identifiers which identify a number of access points corresponding to the initial location information; forwarding the proximate access point identifiers; receiving proximate access point location information associated with at least some of the proximate access point identifiers; determining final location information using the proximate access point location information; and forwarding the final location information.

According to another aspect of the present invention there is provided a method of determining location information for an electronic device, the method comprising: sending initial location information associated with the electronic device; receiving proximate access point identifiers; determining proximate access point location information associated with a number of access points identified by the proximate access point identifiers; sending the proximate access point location information; and receiving and processing final location information.

According to yet another aspect of the present invention there is provided electronic device comprising:a receiver arranged to receive proximate access point identifiers; a processor arranged to determine proximate access point location information associated with a number of access points identified by the proximate access point identifiers; and a transmitter arranged to send initial location information associated with the electronic device and forward the proximate access point location information and wherein the processor is arranged to process final location information received by the receiver.

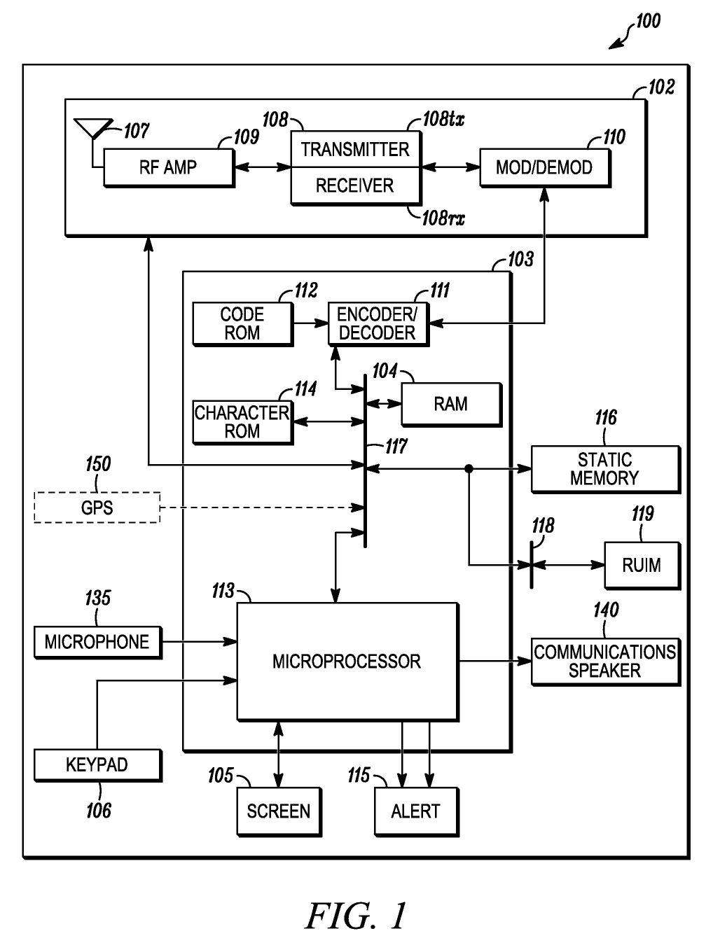

Referring to FIG. 1, there is a schematic diagram illustrating an electronic device 100, typically a wireless communications device, in the form of a mobile station or mobile telephone comprising a radio frequency communications unit 102 coupled to be in communication with a processor 103. The electronic device 100 also has a display screen 105 and a keypad 106. There is also an alert module 115 that typically contains an alert speaker, vibrator motor and associated drivers. The display screen 105. keypad 106, and alert module 115 are coupled to be in communication with the processor 103.

The processor 103 includes an encoder/decoder 111 with an associated code Read Only Memory (ROM) 112 for storing data for encoding and decoding voice or other signals that may be transmitted or received by the electronic device 100. The processor 103 also includes a micro-processor 113 coupled, by a common data and address bus 117, to the radio frequency communications unit 102, the encoder/decoder 111, a character Read Only Memory (ROM) 114, a Random Access Memory (RAM) 104, static programmable memory 116 and a Removable User Identity Module (RUIM) interface 118. The static programmable memory 116 and a RUIM card 119 (commonly referred to as a Subscriber Identity Module (SIM) card) operatively coupled to the RUIM interface 118 each can store, amongst other things, Preferred Roaming Lists (PRLs), subscriber authentication data, selected incoming text messages and a Telephone Number Database (TND phonebook) comprising a number field for telephone numbers and a name field for identifiers associated with one of the numbers in the name field. The RUIM card 119 and static memory 116 may also store passwords for allowing accessibility to password-protected functions on the mobile telephone 100.

The micro-processor 113 has ports for coupling to the display screen 105, keypad 106 and the alert module 115. Also, micro-processor 113 has ports for coupling to a microphone 135 and a communications speaker 140 that are integral with the device.

The character Read Only Memory 114 stores code for decoding or encoding text messages that may be received by the communications unit 102. In this embodiment the character Read Only Memory 114, RUIM card 119, and static memory 116 may also store Operating Code (OC) for the micro-processor 113 and code for performing functions associated with the mobile telephone 100.

The radio frequency communications unit 102 is a combined receiver and transmitter having a common antenna 107. The communications unit 102 has a transceiver comprising a transmitter 108tx and a receiver 108rx coupled to the antenna 107 via a radio frequency amplifier 109. The radio frequency amplifier will typically comprise a power amplifier for amplifying signals from the transmitter 108tx to the antenna and a low noise amplifier for amplifying signals received by the antenna 107 for the receiver 108rx. The transceiver 108 is also coupled to a combined modulator/demodulator 110 that couples the communications unit 102 to the processor 103. The radio frequency communications unit 102 is suitable or arranged to operate according to a number of wireless communications technologies, including for example Bluetooth™, IEEE802.11 (Wi-Fi), cellular protocols such as GSM and 3G (eg CDMA2000 and WCDMA), such protocols or specifications being readily available to and well known by those skilled in the art.

The receiver 108rx is also arranged to scan various channels and/or receive signals from various transmitters such as nearby access points operating using Wi-Fi for example, and to determine a signal strength parameter value such as received signal strength indication (RSSI) for these received signals as will be well known to those skilled in the art. This functionality is widely available on commercially available receivers and is therefore not further discussed here.

The electronic device 100 may also comprise a GPS unit 150 which receives global positioning satellite signals and from these determines GPS position coordinates for the electronic device as is known. These (GPS) global positioning satellite coordinates may be relayed to the processor 103 for displaying to the user and/or for use by other applications within the electronics device 100.

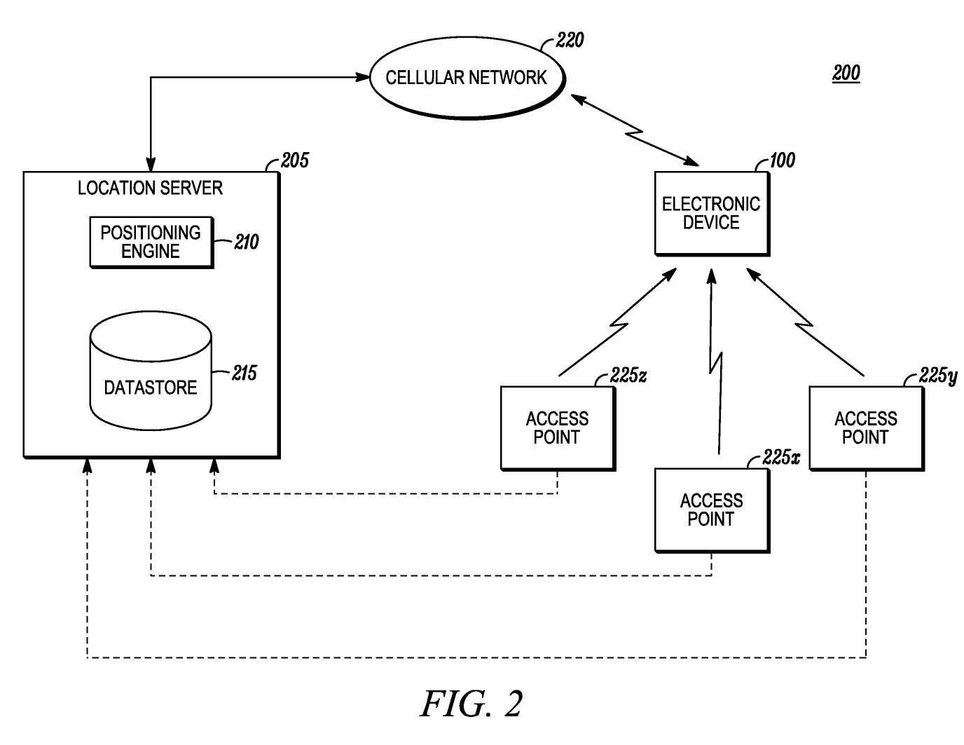

FIG. 2 shows a system for determining location information such as position coordinates or a location identifier of a building for an electronic device such as a mobile phone. The system 200 comprises a location server 205, a cellular network 220, the electronic device 100, and a number of access points 225x, 225y, 225z. The location server 205 is coupled to the cellular network 220, for example by the Internet (not shown), and the cellular network 220 is coupled to the electronic device 100 via a cellular air interface such as CDMA2000. The access points 225x-225z may operate according to a number of wireless protocols such as IEEE802.11 (Wi-Fi) and are in the general area of the mobile terminal 100. Some of the access points 225x-225y may be coupled to the location server 205, for example via the Internet, in order to provide their respective position coordinates to the location server 205. Alternatively, the position coordinates of some of the access points 225x and 225y may be known to the location server 205 by other means, for example manual entry by an operator. Therefore location information is available for these predetermined access points 225x and 225y. The access points 225x-225y may communicate with the electronic device 100 using the exchange of signals conforming to the Wi-Fi protocol for example.

The location server 205 comprises a positioning engine 210, which may be implemented using a processor, memory, and suitable programming software (not shown), together with a datastore 215 which comprises access point identifiers corresponding to some of the access points 225x and 225y. Some access points 225z may not be known to the location server 205 and therefore will not have an entry or corresponding access point identifier in the datastore 215. The datastore 215 also comprises position coordinates for each of the access point identifiers.

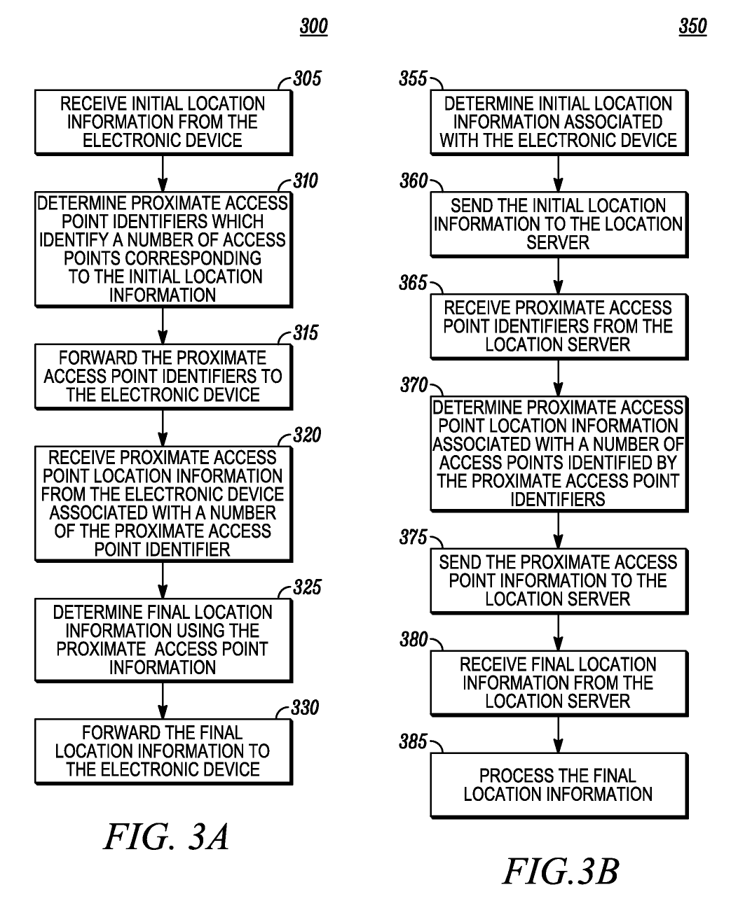

FIG. 3A illustrates a method 300 of determining location information for an electronic device 100, the method 300 being typically performed by the location server 205 in order to determine location information for the electronic device 100. Such location information may be position coordinates, an area identifier (eg “Building A” or “Theatre B”) or a mobile phone cell ID for example. The method 300 receives initial location information from the electronic device at step 305. The initial location information may be received by the positioning engine 210 from the electronic device 100 via the cellular network 220 for example, and may include GPS position coordinates derived from the GPS unit 150. Alternatively a cell identifier which the electronic device 100 retrieved from the cellular network 220 as known may be used. Identifiers or other location information such as position coordinates derived from short range radio system access points may also or alternatively be used.

For example a Bluetooth™ access point or device having a known or likely position may be in radio contact with the electronic device 100, implying that the electronic device is within 10 m of the Bluetooth™ device. The initial location information may then comprise position coordinates corresponding to the Bluetooth™ access point following interrogation by the electronic device 100. Alternatively the MAC address of the Bluetooth™ access point together with an identifier for the type of wireless technology used (Bluetooth™) or a likely range may be provided. This initial location information can then be used to provide approximate position coordinates of the electronic device 100. Similarly, a radio frequency beacon or other device may pass an identifier or other location information to the electronic device indicating a position and which can be used by the electronic device as initial location information. The initial location information may also include previously stored final location information, which is described in more detail below. For example final position coordinates of the electronic device that the method may have previously determined by the method 300 and can be used in a subsequent iteration of the method 300 as initial position coordinates for the initial location information in step 305.

The method 300 then determines proximate access point identifiers for a number of proximate access points (225x and 225y) corresponding to the initial location information at step 310. Where the initial position coordinates are GPS position coordinates, this step (step 310) may be implemented by the positioning engine 210 searching the datastore 215 for access point identifiers having respective position coordinates within a predetermined distance (eg 10 m) of the GPS position coordinates of the electronic device 100 as indicated by the initial location information. The proximate access point identifiers may be the MAC addresses of the respective access points for example. Additional information may also be included to assist the electronic device find these access points, for example the channel number on which the access point would normally operate. Where the initial location information is an identifier for a short range radio system device such as a Bluetooth™ enabled computer for example, the position engine 210 may be configured to identify a position coordinate corresponding to the short range radio system device by further searching in the datastore where this information has been pre-stored in the datastore 215. The position coordinates of this Bluetooth™ computer may then be sufficient for the initial position coordinates for the electronic device 100. The method then searches the datastore for proximate access point identifiers, for example those identifiers which identify access points within 30 m for example of the determined initial position coordinates.

The method 300 then forwards the proximate access point identifiers to the electronic device at step 315. This may be implemented via an Internet connection to the cellular network 220 and on to the electronic device 100 for example. The method 300 then receives proximate access point location information from the electronic device at step 320. The proximate access point location information corresponds to a number of the proximate access point identifiers and may comprise signal strength parameter values such as RSSI values for some or all of the proximate access points identified by the proximate access point identifiers. Thus the proximate access point location information may include proximate access point identifiers and respective RSSI values. The proximate access point location information may also or alternatively comprise direction of (signal) arrival information, or even timing information for a received RF beacon for example. The proximate access point location information may even include position coordinates for respective access points or an estimated range from respective access points.

The method 300 then determines final location information using the proximate access point location information at step 325. The final location information may comprise the estimated final position coordinates for the electronic device 100 or a location identifier such as the name of a building associated with the final position coordinates. Step 325 may be implemented using signal strength parameter values (RSSI) for a number of access points 225x and 225y and included in the proximate access point location information. The position coordinates for these access points may be determined from the datastore 215 using the proximate access point identifiers. A triangulation calculation may then be performed using these access point position coordinates and the respective signal strength parameter values as a proxy for range. Thus the higher the signal strength parameter value the greater the range from the position coordinates of the respective access point. Those skilled in the art will be familiar with triangulation calculations which result in an estimate for the final position coordinates of the electronic device 110. Alternative means may be used for estimating the final position coordinates of the electronic device 100 given the position of the access points and their respective signal strength parameter values or other parameter values which may proxy for range for example.

The final location information may also or alternatively include other details such as a general area or location identifier corresponding to the final position coordinates, such as a particular building within a campus of many buildings for example.

The method 300 then forwards the final location information to the electronic device at step 330. This step (step 330) may be implemented by the positioning engine forwarding a number of packets containing this information over the cellular network 220 to the electronic device 100.

In FIG. 3B there is illustrated a method 350 of determining location information for the electronic device 100, the method 350 being performed by the electronic device 100. At a step 355 the method 350 determines initial location information. This initial location information may be GPS coordinates obtained from a GPS unit 150 within the electronic device 100 for example. Alternatively or additionally, the initial location information may be a cell or base station identifier associated with the cellular network 220. In a GSM cell for example, a base station identifier might be associated with a cell having a radius of the order of between 5-15 km. The initial location information may additionally or alternatively include identifiers or position coordinates and range for base stations associated with short range radio technology devices such as Bluetooth™. The maximum range of Bluetooth™ is generally about 10 m, and so the initial location information may correspond to the area defined by this range and the position coordinates of the Bluetooth™ device. The initial location information may even comprise identifiers (though typically not RSSI measurements) of nearby access points 225x, 225y, 225z, some of which may be stored in the datastore 215. The initial location information may also be recently determined location information, such as the final position coordinates of the electronic device as determined at step 325 sixty seconds ago, and as stored for example in the RAM memory 104.

The method 350 then sends the initial location information to the location server at step 360. This step (step 360) may be implemented by the transmitter 108tx of the electronic device 100 signalling to the cellular network 220.

The method 350 then receives proximate access point identifiers at step 365. The proximate access point identifiers correspond to access points (225x and 225y) which are near the approximate location or initial position coordinates of the electronic device 100 as determined by the location server 205 and as described above. Thus the proximate access point identifiers correspond with the initial location information forwarded to the location server 205. However nearby access points (225z) which are not known to the location server (are not predetermined access points) will not be identified by the proximate access point identifiers.

The method 350 then processes the proximate access point identifiers received from the location server in order to determine proximate access point location information for at least some of the proximate access point identifiers at step 370. The proximate access point location information may comprise signal strength parameter values for some or all of the access points (225x, 225y) corresponding to the proximate access point identifiers. The processing of the proximate access point identifiers may be implemented in the electronic device 100 by the processor 103 instructing the receiver 108rx to scan for signals from each of the access points identified by the proximate access point identifiers, and to measure a signal strength parameter value such as RSSI for the received signals. These signal strength parameter values may then be obtained from the receiver 108rx by the processor 103. It may be that not all of the access points identified by the proximate access point identifiers are transmitting in which case the receiver 108rx will not be able to determine a respective signal strength parameter value. However assuming signal strength parameter values can be determined for at least some of the access points identified by the proximate access point identifiers, then these values may form the proximate access point location information together with respective identifiers such as MAC addresses forming the proximate access point identifiers. In some embodiments a single signal strength parameter value (RSSI measurement) may be sufficient—though this would result in reduced accuracy it may be sufficient for some applications.

The method 350 then sends the proximate access point location information to the location server at step 375. This may be implemented by the transmitter 108tx of the electronic device 100. The method then receives final location information from the location server 205 at step 380. This step may be implemented by the receiver 108rx. The final location information may be final position coordinates for the electronic device, and/or a location identifier for the general location of the electronic device; for example “Building A”.

The method 350 then processes this received final location information at step 385. This step (step 385) may be implemented by the processor 103 identifying and storing position coordinates contained within the received final location information to the memory 104. These position coordinates may then be used as initial location information the next time the method 350 is performed. Various user applications contained within the memory 104, 116 and executed by the processor 103 may also use the final location information, for example to display to the user their current location in position coordinates or as a location identifier such as “Building A”; or even to navigate the user.

These methods 300 and 350 provide various advantages over known arrangements. Because the location server 205 provides the electronic device 100 with proximate access point identifiers, the electronic device does not need to scan for all nearby access points and to measure the RSSI of their respective signals as received by the electronic device. Typically the proximate access point identifiers (225x, 225y) will represent a sub-set of all nearby access points (225x, 225y, 225z) which reduces the time required for scanning and measuring and therefore also conserves battery power and processing resources which could be used for other purposes. Additionally, some of the access point (225z) signals which would otherwise be measured by the electronic device may not have positions known to the location server, which would unnecessarily waste resources such as battery life. Furthermore, by reducing the number of access points of interest, the data or information sent from the electronic device to the location server is reduced—for example to only RSSI measurements relating to the access points (225x, 225y) associated with the provided proximate access point identifiers, instead of all nearby access points (225x, 225y, 225z). This reduces the bandwidth consumed when sending the information from the electronic device 100 to the cellular network 220 for example, which may in turn reduce the cost of the process to the user as well as free up bandwidth resources for other purposes. Furthermore the reduced location information sent reduces congestion on the network (cellular or Internet) as well as the processing and memory resources required by the location server in order to determine final location information.

The electronic device method 350 may include an additional step (not shown) preceding step 355 in which the electronic device first determines whether it has any initial location information. If it does, the method proceeds as described previously. If however there is no initial location information available, the method reverts to a method where all nearby access points are scanned for, identified, and RSSI measurements taken. This access point information, corresponding to the proximate access point location information, is then forwarded to the location server 205. The location server 200 uses this access point location information (for all nearby access points not just those identified by the location server) to determine the final location information which is then forwarded to the electronic device 100. It can be seen that if there are a large number of nearby access points that do not have locations known by the location server, then there is considerable waste of battery, electronic device processing, bandwidth, network, and location server processing resources.

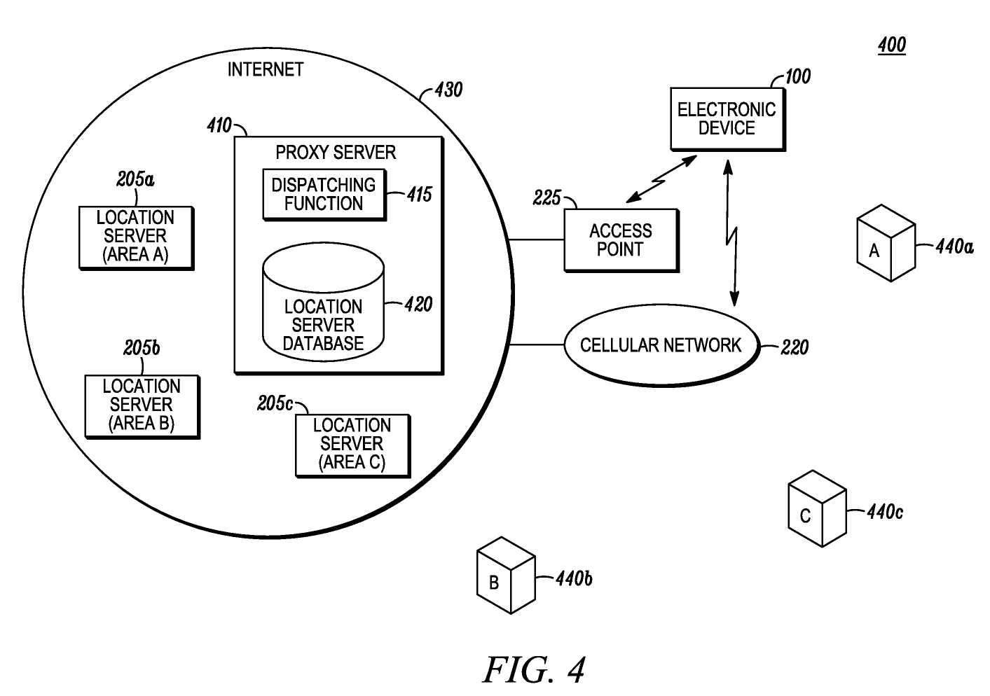

FIG. 4 shows a system for determining location information such as position coordinates for an electronic device according to an alternative embodiment. The system 400 comprises a number of location servers 205a, 205b, 205c each associated with respective locations, areas or buildings 440a, 440b, 440c as shown. Typically the location servers 205a-205c will be located within their respective buildings. The location servers 205a-205c are coupled to a proxy server 410 via the Internet 430, the proxy server 410 comprising a dispatching function 415 and a location server database 420. An electronic device 100 and a number of access points 225 are coupled to the location servers 205 as previously described with respect to FIG. 2; for example via a cellular network 220.

Each location server 205a-205c stores access point location information in a respective datastore 215 that relates to access points 225 within its respective location or building 440a-440c. The electronic device 100 however is arranged to request location information from the proxy server 410 initially, the request comprising initial location information as previously described. On the basis of the received initial location information, the dispatching function 415 of the proxy server 410 identifies the nearest location area or building and allocates a location server on this basis. For example if the initial location information corresponds to a position coordinate or a location identifier associated with building A, then the A location server 205a is allocated. The dispatching function 415 then passes the initial location information and the electronic device's received address or other suitable identifier to the allocated location server 205a. The allocated location server 205a receives the initial location information from the proxy server 410 and then performs the method of FIG. 3A (from step 310). The electronic device 100 performs a similar method to that illustrated in FIG. 3B, but instead of sending the initial location information directly to a location server 210, this is sent first to the proxy server 410. The electronic device 100 then resumes the method 350 at step 365 where it receives the proximate access point identifiers from the allocated location server 205a. In alternative arrangements the various communicated information (initial location information, proximate access point identifiers, proximate access point location information, and final location information) could be sent or received from different entities where the various functions of the systems of FIGS. 2 and 4 are distributed in a different manner as would be apparent to those skilled in the art.

An example application is described below with respect to FIG. 4, in which a visitor to a movie theatre is guided to their seat. When the user (visitor) purchases a ticket or validates the ticket at the theatre entrance, the entrance location may be transferred electronically to the user's electronic device 100, for example a cellular phone, together with the location of the user's seat, for example together with an electronic ticket. The electronic device 100 transmits the theatre's entrance location as its initial location information to the proxy server 410. The dispatching function 415 then allocates the location server 205b to be used for determining the final location information from the initial location information received from the electronic device 100. The dispatching function 415 then forwards the initial location information to the allocated location server 205b. The location server 205b searches its datastore 215 for access points located in the movie theatre and that are appropriate for gathering location information from. These will include access points located on the same floor and which are nearby the electronic device 100. The location server 205 then creates a list of these access points (proximate access point identifiers) and transmits this list to the electronic device 100.

The electronic device 100 then measures RSSI and/or other signal strength parameter values for the listed or identified proximate access points, and transmits this proximate access point location information to the location server 205b. The location server 205b then calculates the location (final position coordinates) of the electronic device 100 from this proximate access point location information, and notifies the electronic device 100 of its physical position (final location information).

The electronic device 100 may additionally include software that navigates the user to their seat by periodically updating the initial location information and/or receiving updated lists of access points (proximate access point identifiers) to measure RSSI from. The location server receives these updated measurements (proximate access point location information) and updates the location calculation, thus the electronic device receives updated final location information which can be used to direct the user to the previously received position coordinates of their allocated seat.

By distributing location servers 205a-205c as shown in FIG. 4, the number of access points covered by each location server is reduced which reduces the network load and/or the load on each location server 205a-205c.

The skilled person will recognise that the above-described apparatus and methods may be embodied as processor control code, for example on a carrier medium such as a disk, CD- or DVD-ROM, programmed memory such as read only memory (Firmware), or on a data carrier such as an optical or electrical signal carrier. For some applications embodiments of the invention may be implemented on a DSP (Digital Signal Processor), ASIC (Application Specific Integrated Circuit) or FPGA (Field Programmable Gate Array). Thus the code may comprise conventional programme code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog™ or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

The skilled person will also appreciate that the various embodiments and specific features described with respect to them could be freely combined with the other embodiments or their specifically described features in general accordance with the above teaching. The skilled person will also recognise that various alterations and modifications can be made to specific examples described without departing from the scope of the appended claims.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of determining location information for an electronic device, the method comprising:
receiving initial location information associated with the electronic device;
determining proximate access point identifiers which identify a number of access points corresponding to the initial location information;
forwarding the proximate access point identifiers;
receiving proximate access point location information associated with at least some of the proximate access point identifiers;
determining final location information using the proximate access point location information; and
forwarding the final location information.

2. A method as claimed in claim 1, wherein the initial location information is selected from the group consisting of: global positioning satellite coordinates; short range radio system access point location information; cellular radio system location information; and previous final location information.

3. A method as claimed in claim 1, wherein determining the proximate access point identifiers comprises determining an initial position coordinate for the electronic device from the initial location information and identifying predetermined access points having respective position coordinates that are within a predetermined distance of the initial position coordinates for the electronic device.

4. A method as claimed in claim 1, wherein the proximate access point location information comprises a signal strength parameter value for a respective proximate access point identifier.

5. A method as claimed in claim 4, wherein determining final location information using the proximate access point location information comprises using triangulation of position coordinates of the predetermined access points associated with the proximate access point location information and their respective signal strength parameter values to calculate a final position coordinates for the electronic device.

6. A method as claimed in claim 5, wherein the final location information comprises the final position coordinates for the electronic device.

7. A method as claimed in claim 5, wherein the final location information comprises
a location identifier associated with the final position coordinates for the electronic device.

8. A method as claimed in claim 1, wherein the proximate access point location information comprises a received signal strength indication.

9. A method of determining location information for an electronic device, the method comprising:
sending initial location information associated with the electronic device;
receiving proximate access point identifiers;
determining proximate access point location information associated with a number of access points identified by the proximate access point identifiers;
sending the proximate access point location information; and
receiving and processing final location information.

10. A method as claimed in claim 9, wherein the determining proximate access point location information comprises measuring signal strength parameter values for signals received from the number of access points identified by the proximate access point identifiers.

11. A method as claimed in claim 9 wherein the initial location information is selected from the group consisting of: global positioning satellite coordinates; short range radio system access point location information; cellular radio system location information; and previous final location information.

12. A method as claimed in claim 9, wherein the final location information comprises the final position coordinates for the electronic device.

13. A method as claimed in claim 9, wherein the final location information comprises
a location identifier associated with the final position coordinates for the electronic device.

14. A method as claimed in claim 9, wherein the determining proximate access point location information comprises measuring at least one received signal strength indication value.

15. An electronic device comprising:
a receiver arranged to receive proximate access point identifiers;
a processor arranged to determine proximate access point location information associated with a number of access points identified by the proximate access point identifiers; and
a transmitter arranged to send initial location information associated with the electronic device and forward the proximate access point location information and wherein the processor is arranged to process final location information received by the receiver.

16. An electronic device as claimed in claim 15, wherein the processor is arranged to obtain from the receiver, signal strength parameter values for signals received from access points corresponding to the proximate access point identifiers in order to determine the proximate access point location information.

17. An electronic device as claimed in claim 12, wherein the processor is arranged to store the final location information in a memory thereof.
